(19) United States
(12) Patent Application Publication
(10) Pub. No.: US 2002/0186885 A1
(43) Pub. Date: Dec. 12, 2002

(54) Verifying results of automatic image recognition

(76) Inventors: Aviad Zlotnick, Galil Takhton (IL); Eugene Walach, Kiryat Motzkin (IL)

Correspondence Address: McGuireWoods LLP, Suite 1800, 1750 Tysons Boulevard, Tysons Corner, McLean, VA, 22102-3915, US

(21) Appl. No.: 09/878,291

(22) Filed: Jun. 12, 2001

(51) Int. Cl. G06K 9/62

(52) U.S. Cl. 382/224; 382/311

(57) ABSTRACT

A method for image processing includes analyzing one or more images so as to determine a respective classification for each of a multiplicity of elements in the images, wherein the elements are not individual characters in a language or numerical system. A plurality of the elements that have the same classification and were found at different locations in the one or more images are displayed together for a human operator. An input is received from the operator indicative of whether the computer erred in the classification of any of the displayed elements.

### FIELD OF THE INVENTION

The present invention relates generally to computerized image recognition systems, and specifically to methods and systems for enabling human operators to verify results in such systems.

### BACKGROUND OF THE INVENTION

There are many methods known in the art for enabling human operators to verify results of computerized optical character recognition (OCR). These methods have arisen out of the need for very high accuracy in coding of textual and numeric characters, particularly in the area of document processing. For example, when checks are processed for clearing by a bank, errors in reading the amount of the check can be very expensive. Because verification by human operators is typically the most costly step in document processing, as well as one of the least reliable steps, techniques have been developed for facilitating this step.

U.S. Pat. No. 5,455,875, whose disclosure is incorporated herein by reference, describes a system and method for correction of OCR with display of image segments according to character data. The method is implemented in document processing systems produced by IBM Corporation (Armonk, N.Y.), in which the method is referred to as “SmartKey.” The system presents to the human operator a “carpet” of character images on the screen of a computer terminal. The character images, each containing a single character, are produced by segmenting the original document images that were processed by OCR. Segmented characters from multiple documents are sorted according to the codes assigned to them by the OCR. The character images are then grouped and presented in the carpet for verification according to their assigned code.

For example, the operator might be presented with a carpet of characters that the OCR has identified as representing the letter “a.” Under these conditions, it is relatively easy for the operator to visually identify OCR errors, such as a handwritten “o” that was erroneously identified as an “a.” The operator marks erroneous characters by clicking on them with a mouse. Thus, displaying the composite, “carpet” images to the operator, made up entirely of characters which have been recognized by the OCR logic as being of the same type, enables the operator to rapidly recognize and mark errors on an exception basis. Once recognized, these errors can then either be corrected immediately or sent to another operator for correction. The remaining, unmarked characters in the carpet are considered to have been verified.

Because of the ubiquity of OCR applications, far more research and development effort has been invested in OCR (including OCR verification) than in other branches of computerized image recognition that do not deal exclusively with characters. In the context of the present patent application and in the claims, the term “character” is used in its conventional sense, to refer to a symbol that serves as an atomic unit of representation in a written language or numerical system. Characters are atomic in the sense that they cannot be divided into smaller sub-units without losing their linguistic or numerical meaning. Thus, characters that are segmented, recognized and verified in OCR systems are generally individual letters and digits, although they may also be atomic representations of complex sounds, as in Chinese or Japanese. On the other hand, the inventors are unaware of any publications suggesting methods or systems for efficient verification of non-character computer image recognition results.

### SUMMARY OF THE INVENTION

Preferred embodiments of the present invention provide an efficient and reliable method for verifying results of automated image recognition for applications in which the image features that are recognized are not individual characters in a language or numerical system. After computer analysis has identified certain image elements in a group of images (or possibly in a single large image), a number of the elements that were assigned the same classification are displayed together for a human operator. The elements are typically selected and cropped from different locations in the images. They are preferably displayed together for the operator in a grid pattern on a computer screen, as in the above-mentioned SmartKey system. The operator can then verify that all of the elements were correctly classified and, if necessary, can indicate to the computer which classifications may be erroneous, typically by using a pointing device, such as a mouse, to select the incorrectly-identified elements in the grid display.

The present invention thus extends the advantages of accurate and efficient verification of image recognition results to a broad range of applications beyond the field of OCR. Applications that may benefit from the present invention include, for example, computer recognition of words, of non-character symbols and of features of three-dimensional objects. Other applications will be apparent to those skilled in the art. Although preferred embodiments are described herein with reference to verifying results of image analysis performed automatically by a computer, the principles of the present invention can similarly be applied to verifying results of image feature recognition performed by human operators.

There is therefore provided, in accordance with a preferred embodiment of the present invention, a method for image processing, including:

analyzing one or more images so as to determine a respective classification for each of a multiplicity of elements in the images, wherein the elements are not individual characters in a language or numerical system;

displaying together for a human operator a plurality of the elements that have the same classification and were found at different locations in the one or more images; and

receiving an input from the operator indicative of whether the computer erred in the classification of any of the displayed elements.

In a preferred embodiment, the elements include pictures of three-dimensional image features. In another preferred embodiment, the elements include words of more than one character. In still another preferred embodiment, the elements include non-alphanumeric symbols.

Typically, analyzing the one or more images includes carrying out a process of automated image analysis using a computer.

Preferably, displaying the plurality of the elements includes dividing the one or more images into segments, such that one of the plurality of the elements is contained in each of the segments, and displaying the segments containing the elements. Most preferably, displaying the segments includes displaying the segments in a grid pattern on a computer display.

Further preferably, displaying the segments includes displaying the segments on a computer display, and receiving the input includes sensing a selection of one of the plurality of the elements on the computer display, wherein the selection is made by the operator using a pointing device associated with the computer. Typically, the selection of the one of the elements indicates that the classification of the element is erroneous. In a preferred embodiment, the operator is prompted to correct the erroneous classification.

There is also provided, in accordance with a preferred embodiment of the present invention, apparatus for image processing, including a verification terminal, which is arranged to verify results of analyzing one or more images so as to determine a respective classification for each of a multiplicity of elements in the images, wherein the elements are not individual characters in a language or numerical system, by displaying together for a human operator a plurality of the elements that have the same classification and were found at different locations in the one or more images, and receiving an input from the operator indicative of whether the computer erred in the classification of any of the displayed elements.

Preferably, the apparatus includes a display screen, which is driven by the terminal to display the segments, and a pointing device, which is coupled to the terminal so as to be used by the operator to select one of the plurality of the elements on the computer display.

There is additionally provided, in accordance with a preferred embodiment of the present invention, a computer software product, including a computer-readable medium in which program instructions are stored, which instructions, when read by a computer, cause the computer to verify results of analyzing one or more images so as to determine a respective classification for each of a multiplicity of elements in the images, wherein the elements are not individual characters in a language or numerical system, by displaying together for a human operator a plurality of the elements that have the same classification and were found at different locations in the one or more images, and receiving an input from the operator indicative of whether the computer erred in the classification of any of the displayed elements.

The present invention will be more fully understood from the following detailed description of the preferred embodiments thereof, taken together with the drawings in which:

### BRIEF DESCRIPTION OF THE DRAWINGS

FIG. 1 is a schematic, pictorial illustration of apparatus for verification of computer image recognition results, in accordance with a preferred embodiment of the present invention;

FIG. 2 is a flow chart that schematically illustrates a method for verification of computer image recognition results, in accordance with a preferred embodiment of the present invention; and

FIGS. 3-5 are schematic representations of a computer screen display presenting computer image results for verification, in accordance with preferred embodiments of the present invention.

### DETAILED DESCRIPTION OF PREFERRED EMBODIMENTS

FIG. 1 is a schematic, pictorial illustration of apparatus 20 for verification of computer image recognition results, in accordance with a preferred embodiment of the present invention. An image capture device 22, typically a scanner or digital camera, generates an electronic image, which is processed by a computer to identify specified image features. The identified features are cropped from their original images and are grouped with other features that have been assigned the same identification. A verification terminal 24 displays the grouped features on a monitor screen 26 for verification by a human operator. The operator uses input devices such as a keyboard 28 and a mouse 30 to mark any incorrect identifications and, optionally, to correct them, as well. Terminal 24 maintains a link between each displayed feature and location of the feature in the original image in which it appeared, so that inputs by the operator can be linked back to the original images for verification or correction of image recognition results.

Terminal 24 typically comprises a general-purpose personal computer or other suitable computing device, which is equipped with software for carrying out the functions of the present invention, as described herein. The software may be downloaded to terminal 24 in electronic form, over a network, for example, or it may alternatively be supplied on tangible media, such as CD-ROM or DVD, for installation on the terminal. Alternatively, terminal 24 may comprise custom hardware elements with firmware for performing these functions.

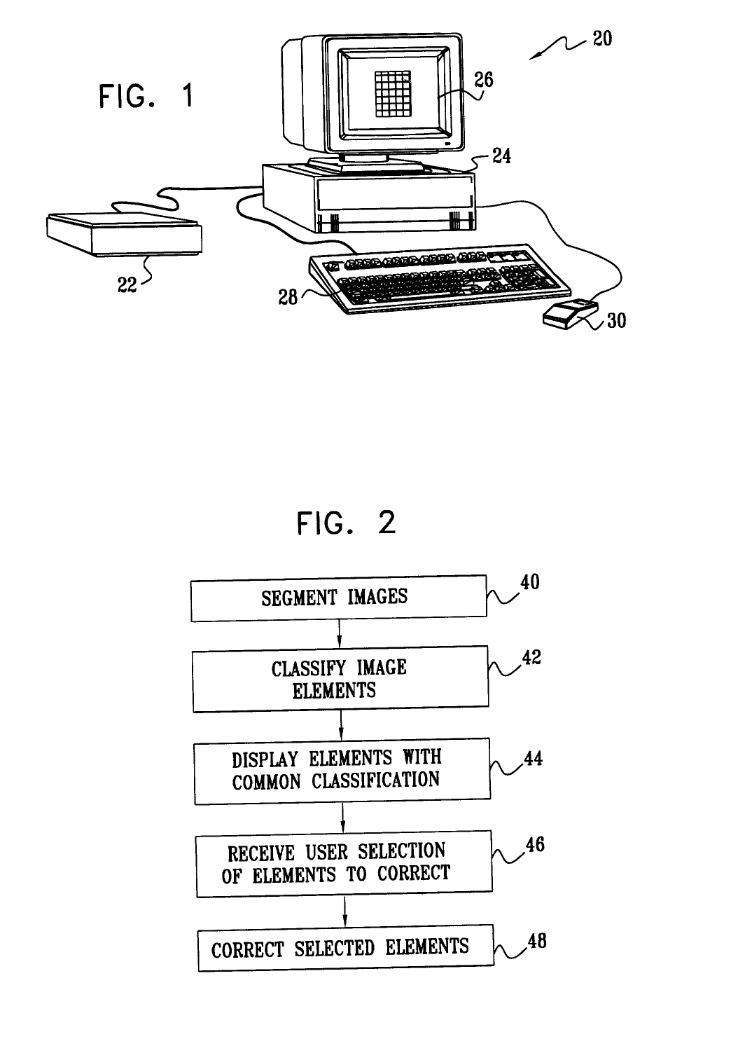

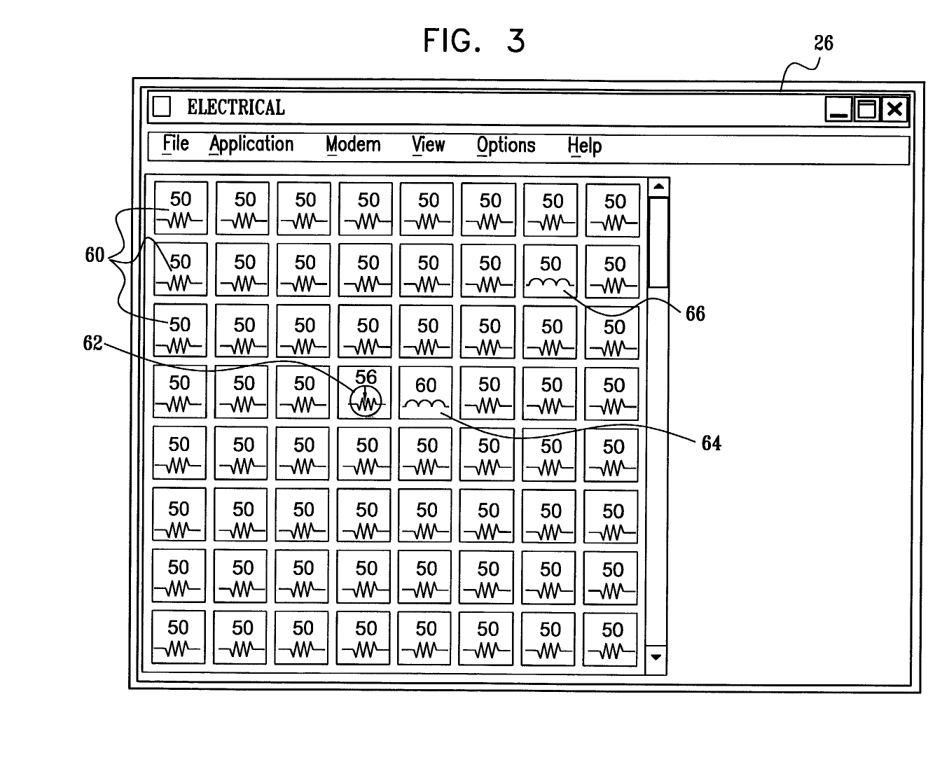

FIG. 2 is a flow chart that schematically illustrates a method for verifying image recognition results, in accordance with a preferred embodiment of the present invention. At a segmentation step 40, an image processing computer (not shown) identifies elements or features of possible interest in an image or set of images. Examples of element types to which the present method can be applied are shown in FIGS. 3-5 and described hereinbelow. The computer segments the image into regions of interest, typically rectangular regions, each containing a single one of the elements. The computer processes the elements, using methods of image analysis known in the art, to determine an identification or classification for each of the elements, at a classification step 42.

In preparation for verification of the recognition results, the elements identified and classified in steps 40 and 42 are grouped by classification, at a classification grouping step 44. Terminal 24 receives a group of such elements, sharing a common classification, and displays the regions of interest containing the elements in a grid pattern on screen 26. This arrangement is similar to a SmartKey carpet of character images, as described in the above-mentioned U.S. Pat. No. 5,455,875, except that in preferred embodiments of the present invention, the image elements are not individual characters. An operator viewing screen 26 is informed of the common classification and selects the elements that do not fit the classification, at a user selection step 46. Preferably, the operator identifies the incorrectly-classified elements for terminal 24 by clicking on them with mouse 30.

When the operator has finished selecting the incorrect elements (or when there are no incorrect elements on the screen), he or she indicates to the terminal that verification of this screen is completed, typically by clicking on a “DONE” button on screen 26 or pressing a key, such as the “ENTER” key, on keyboard 28. Any elements on the screen that have not been selected by the operator as erroneous are marked by terminal 24 as having been verified. Optionally, the operator enters the correct classification of the incorrectly-classified elements, at a correction step 48. Alternatively, the correction may be carried out by a different operator, who typically views the elements to be corrected in their original context. Terminal 24 maintains a link between each of the elements displayed on screen 26 and its original location in one of the input images, so that the verification and/or correction of the element can be properly associated with the original location.

FIG. 3 is a schematic illustration of screen 26, on which a grid of image elements 60 is presented for verification, in accordance with a preferred embodiment of the present invention. In this example, a group of electrical schematic diagrams was processed by computer so as to identify symbols corresponding to fifty-ohm resistors, and the results are presented on screen 26. An operator viewing screen 26 marks elements 62, 64 and 66, by clicking on them with mouse 30, as being symbols of other types, which were erroneously identified as resistors. Optionally, the operator may also verify that the computer has correctly read the numbers associated with each of the symbols.

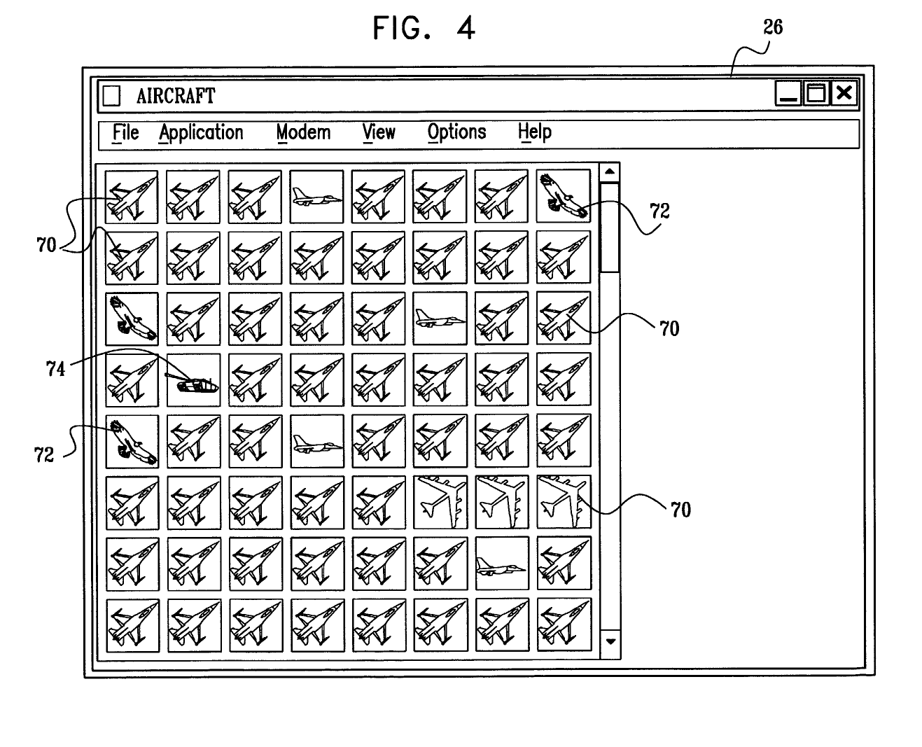

FIG. 4 is a schematic illustration of screen 26, on which a grid of image elements 70 is presented for verification, in accordance with another preferred embodiment of the present invention. In this case, the computer has processed an aerial reconnaissance image in order to identify aircraft appearing in the image. The operator marks elements 72 and 74 as comprising image features other than aircraft. Similar verification techniques may be used in other image analysis and inspection applications, such as identifying and checking the values of electrical components inserted into a printed circuit board. A similar type of display and approach can be used for verifying results of image analysis and feature identification performed by human operators.

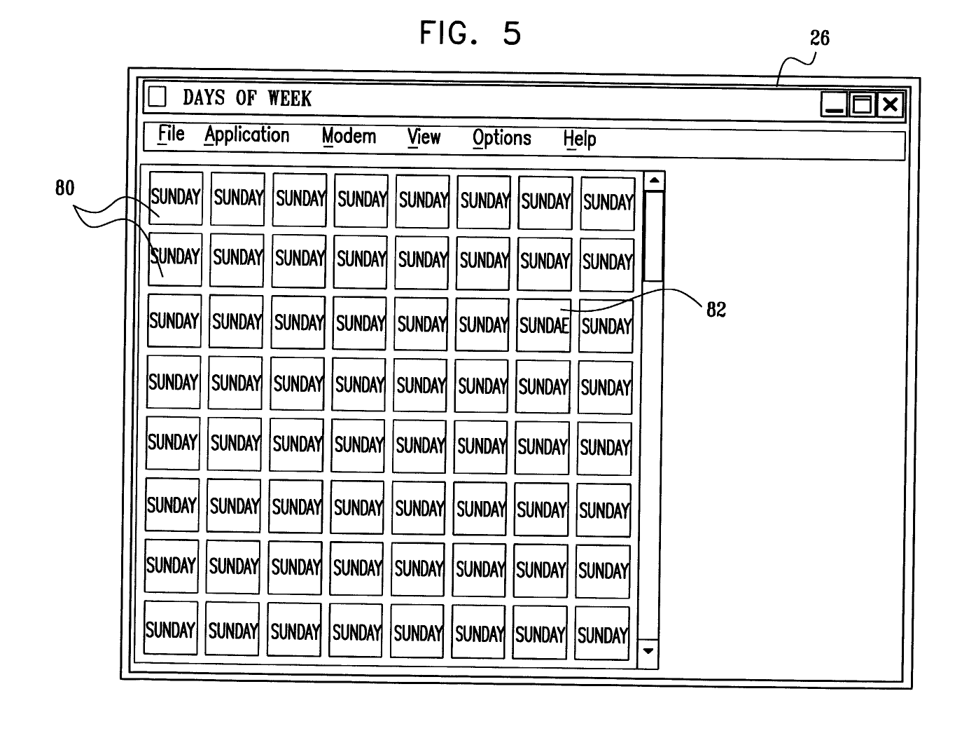

FIG. 5 a schematic illustration of screen 26, on which a grid of image elements 80 is presented for verification, in accordance with yet another preferred embodiment of the present invention. In this case, the computer has scanned a set of documents in order to locate occurrences of a given word, such as the day of the week, “Sunday.” An element 82, however, referring to an ice cream sundae, has been mistakenly classified by the computer. The operator marks this element for correction.

It will be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for image processing, comprising:
analyzing one or more images so as to determine a respective classification for each of a multiplicity of elements in the images, wherein the elements are not individual characters in a language or numerical system;
displaying together for a human operator a plurality of the elements that have the same classification and were found at different locations in the one or more images; and
receiving an input from the operator indicative of whether the computer erred in the classification of any of the displayed elements.

2. A method according to claim 1, wherein the elements comprise pictures of three-dimensional image features.

3. A method according to claim 1, wherein the elements comprise words of more than one character.

4. A method according to claim 1, wherein the elements comprise non-alphanumeric symbols.

5. A method according to claim 1, wherein analyzing the one or more images comprises carrying out a process of automated image analysis using a computer.

6. A method according to claim 1, wherein displaying the plurality of the elements comprises dividing the one or more images into segments, such that one of the plurality of the elements is contained in each of the segments, and displaying the segments containing the elements.

7. A method according to claim 6, wherein displaying the segments comprises displaying the segments in a grid pattern on a computer display.

8. A method according to claim 1, wherein displaying the segments comprises displaying the segments on a computer display, and wherein receiving the input comprises sensing a selection of one of the plurality of the elements on the computer display, wherein the selection is made by the operator using a pointing device associated with the computer.

9. A method according to claim 8, wherein the selection of the one of the elements indicates that the classification of the element is erroneous.

10. A method according to claim 9, and comprising prompting the operator to correct the erroneous classification.

11. Apparatus for image processing, comprising a verification terminal, which is arranged to verify results of analyzing one or more images so as to determine a respective classification for each of a multiplicity of elements in the images, wherein the elements are not individual characters in a language or numerical system, by displaying together for a human operator a plurality of the elements that have the same classification and were found at different locations in the one or more images, and receiving an input from the operator indicative of whether the computer erred in the classification of any of the displayed elements.

12. Apparatus according to claim 11, wherein the elements comprise pictures of three-dimensional image features.

13. Apparatus according to claim 11, wherein the elements comprise words of more than one character.

14. Apparatus according to claim 11, wherein the elements comprise non-alphanumeric symbols.

15. Apparatus according to claim 11, wherein the one or more images are analyzed by a process of automated image analysis using a computer.

16. Apparatus according to claim 11, wherein the one or more images are divided into segments, such that one of the plurality of the elements is contained in each of the segments, and wherein the terminal is arranged to display the segments containing the elements.

17. Apparatus according to claim 16, and comprising a display screen, which is driven by the terminal to display the segments in a grid pattern.

18. Apparatus according to claim 11, and comprising a display screen, which is driven by the terminal to display the segments, and a pointing device, which is coupled to the terminal so as to be used by the operator to select one of the plurality of the elements on the computer display.

19. Apparatus according to claim 18, wherein selection of the one of the elements by the operator indicates that the classification of the element is erroneous.

20. Apparatus according to claim 19, wherein the terminal is arranged to prompt the operator to correct the erroneous classification.

21. A computer software product, comprising a computer-readable medium in which program instructions are stored, which instructions, when read by a computer, cause the computer to verify results of analyzing one or more images so as to determine a respective classification for each of a multiplicity of elements in the images, wherein the elements are not individual characters in a language or numerical system, by displaying together for a human operator a plurality of the elements that have the same classification and were found at different locations in the one or more images, and receiving an input from the operator indicative of whether the computer erred in the classification of any of the displayed elements.

22. A product according to claim 21, wherein the elements comprise pictures of three-dimensional image features.

23. A product according to claim 21, wherein the elements comprise words of more than one character.

24. A product according to claim 21, wherein the elements comprise non-alphanumeric symbols.

25. A product according to claim 21, wherein the one or more images are analyzed by a process of automated image analysis using an image processor.

26. A product according to claim 21, wherein the one or more images are divided into segments, such that one of the plurality of the elements is contained in each of the segments, and wherein the instructions cause the computer to display the segments containing the elements.

27. A product according to claim 26, wherein the instructions cause the computer to display the segments in a grid pattern.

28. A product according to claim 21, wherein the instructions cause the computer to display the segments, and to receive an input made by the operator using a pointing device to select one of the plurality of the elements on the computer display.

29. A product according to claim 28, wherein selection of the one of the elements by the operator indicates that the classification of the element is erroneous.

30. A product according to claim 29, wherein the instructions cause the computer to prompt the operator to correct the erroneous classification.
